(19) United States
(12) Patent Application Publication
(10) Pub. No.: US 2025/0296612 A1
(43) Pub. Date: Sep. 25, 2025

(54) ADAPTABLE UTILITY CART

(71) Applicant: TechMaster Carts, LLC, Mounds View, MN (US)

(72) Inventors: Timothy Koes, Blaine, MN (US); Yudah Amit, Eden Praire, MN (US)

(21) Appl. No.: 19/232,272

(22) Filed: Jun. 9, 2025

Related U.S. Application Data
(63) Continuation-in-part of application No. 18/444,163, filed on Feb. 16, 2024.

(51) Int. Cl. B62B 3/00; B62B 5/06

(52) U.S. Cl. CPC B62B 3/005; B62B 3/003; B62B 5/06; B62B 2202/48; B62B 2202/56; B62B 2207/00; B62B 2301/04632; B62B 2501/065

(57) ABSTRACT

A utility cart suited for use in a variety of settings including a biomedical environment that includes a upper tray and a lower tray, configured to store and transport items. The panels making up the utility cart are interlocked using specific grooves and slots to provide rigidity. The utility cart also includes a drawer for storage, and specific coupling elements that allow the cart to be coupled with related devices, such as a second utility cart. Also included are customizable panels easily placed on the sides and back of the utility cart, as well as on a drawer fronts, which are printable using sublimation printing such that the cart may include custom colors, signs, or labels.

### BACKGROUND OF THE INVENTION

Rolling carts are widely used in many industries to store and provide easy access to various supplies, tools, equipment, and other items. These rolling carts may be found in medical facilities, manufacturing facilities, repair shops, hobby shops, retail stores, as well as innumerable other settings. Medical facilities provide one example where a clean, efficient and effectively designed cart is especially important. Due to the delicate nature of medical procedures and the environmental standards of medical facilities, any cart used to assist in medical care must be well built, operate smoothly, and meet strict sterilization requirements. Further, medical carts are typically designed to be multifunctional, and often carry mechanisms to facilitate a number of electronics, cords, lights, instruments, and supplies, all capable of use in sterile environments. As an example, a medical procedure room, such as an operating room requires the existence of a cart that is easily rolled into position, is easily sterilized, and provides numerous conveniences such as adjustability, usable surface area, organization, and easy access to stored contents.

### SUMMARY

Described below are various embodiments of rolling carts that addresses the aforementioned needs. Generally, a cart assembly will have a plurality of drawers, a back cabinet door that opens to expose a cable locker, folding side tables that may interlock with similar folding side tables of adjacent carts, and multiple surfaces suitable to receive sublimation printing. The cart assembly is particularly well suited to medical applications, but the design is equally suitable for other uses. In another embodiment, a utility cart is described with will have open storage areas that are easily accessible. The utility cart may also optionally have a drawer that provides additional storage space which can be used for many purposes. The utility cart is also well suited for medical applications, but can also be used in many settings.

In at least one embodiment, various laminate panels are used, with each having surfaces which are suitable for sublimation printing. These laminate panels are easily applied to one or more of the outside surfaces of the cart assembly or the utility cart. The outside surfaces of the carts and surfaces of various cart components are configured to be substrates for the printable panels, including any or all of the vertical surfaces including the drawer fronts. The laminate panels can be constructed of any material, such as aluminum, which accepts sublimation printing. These panels may be attached to the substrate surfaces using double sided tape, hook and loop fasteners, adhesives or mechanical attachment structures (as an example, this may include upper and lower slots sized to allow the panels to be slid into place). Alternatively, the panels may be attached magnetically to the substrate surfaces. The use of panels capable of supporting high resolution graphics and images (via sublimation printing or similar printing techniques) provides an ability generate carts that are visually appealing and customizable. The versatility of these printable panels can also allow the cart to be repurposed by swapping panels to convey different information, such as logos, customized images, drawer contents, use status, warnings, colors, advertisements, and the like. It is also contemplated that the drawer panels present an opportunity to create one or more larger graphic designs that occupy multiple drawers.

In one embodiment, the cart may include a cable locker positioned at the rear of the cart which can contain organizing features such as hooks, loops, belts, magnets, posts, pegs, etc., to name a few non-limiting examples. Other examples of components that may be housed within cable locker include components to facilitate data communication, such as switches, routers, network ports, etc. Further, the cable locker will typically include a door to enclose the contents thereof.

In another embodiment, the cart assembly includes a mounting bracket for computer equipment, such as a keyboard, monitor or display. This bracket could further provide support for a laptop computer or a tablet, thus providing a user with access to computing systems.

In at least one additional embodiment, the cart assembly is an assembly comprising: a top, a front, a left side, a right side, and a back. The top may include a top panel that defines a flat work surface. The top panel may further include features such as one or more recessed trays and a power strip. The top may further support a pole attached thereto, which is extending upwardly from the top panel and constructed to provide an attachment point for accessories, such as monitor swing arms, laptop mounts, IV bag hangers, and the like.

At least one further embodiment of the cart assembly also provides a plurality of drawers that may be opened from the front. The drawers may include known features such as laser-cut foam for tool organization, padded floors to prevent unwanted noise and shifting, and soft closing drawer slides.

In another aspect, a left side and a right side of the cart assembly may include easy access baskets and a folding table extension. The folding table extension may include a distal edge that is configured to mate with a table extension of an adjacent cart assembly to extend the working space significantly. The folding table extension may be constructed and arranged for easily changing the side of the cart assembly to which it is mounted.

At least one of the left side and the right side also includes one or more handles that, in conjunction with large independent casters, allow for ease of maneuverability of the cart assembly. The casters are further constructed from precision materials to accommodate smooth and quite movement of the cart assembly.

Again, a cord locker may be included as part of the cart assembly, which provides an internal space for storing cords and is accessible from a door in the back. The cord locker may include one or a plurality of hooks, loops, or similar cable managers. The cord locker may further include one or more power strips, preferably with a long cord on at least one of the power strips, so that the cart assembly may be able to be powered from a wide variety of locations in a space, without requiring undesired placement in order to reach an outlet. When close to an outlet, the extra length of cord is looped around the cable manager. An access port or hole in the top surface of the cart assembly allows electronics associated with the cart assembly to be easily powered without excess cord exposure. The extra lengths of cord may also be looped around one or more of the cable managers. In one aspect, the wherein the at least one power strip may be plugged into an outlet outside of the cart assembly assembly while the door is closed and excess cord from the at least one power strip may be looped around the at least one cable manager.

In another embodiment, the utility cart is configured to have a bottom supporting surface to hold various components, tools, supplies, parts, etc. Further, the utility cart has an upper supporting surface that is also configured to hold components, tools, supplies, parts, etc. each of the supporting surfaces are surrounded by walls and can selectively receive dividers to create compartments. A pair of uprights connect the lower and upper supporting structures, and wheels are provided on a bottom portion of the utility cart to allow easy movability. Further, the utility cart may include a drawer or drawers to provide additional storage.

### BRIEF DESCRIPTION OF THE DRAWINGS

These and other aspects, features and advantages will be apparent and elucidated from the following description with reference being made to the accompanying drawings, in which:

FIG. 1 is a front-right perspective view of an embodiment of a cart assembly according to the invention;

FIG. 2 is a rear-left perspective view of an embodiment of a cart assembly according to the invention;

FIG. 3 is a top plan view of an embodiment of a cart assembly according to the invention;

FIG. 4 is front elevation of an embodiment of a cart assembly according to the invention;

FIG. 5 is a right elevation of an embodiment of a cart assembly according to the invention;

FIG. 6 is a top plan view of an embodiment of a cart assembly according to the invention;

FIG. 7 is a rear elevation of an embodiment of a cart assembly according to the invention;

FIG. 8 is a left elevation of an embodiment of a cart assembly according to the invention;

FIG. 9 is a perspective view of an embodiment of a cable manager according to the invention;

FIG. 10 is a front elevation of an embodiment of a cable manager according to the invention;

FIG. 11 is a top plan view of an embodiment of a cable manager according to the invention;

FIG. 12 is a side elevation of an embodiment of a cable manager according to the invention;

FIG. 13 is a front elevation of an embodiment of an embodiment of a cart according to the invention;

FIG. 14 is a sectional view taken along section lines 14-14 of FIG. 13;

FIG. 15 is a sectional view taken along section lines 15-15 of FIG. 13;

FIG. 16 is a plan view of an embodiment of a floor panel according to the invention;

FIG. 17 is a perspective view of an embodiment of a side panel according to the invention;

FIG. 18 is a top view of an embodiment of a side panel according to the invention;

FIG. 19 is a perspective view of an embodiment of an interior wall according to the invention;

FIG. 20 is a detailed to view of a tongue feature of an embodiment of an interior wall according to the invention;

FIG. 21 is a front elevation of three carts connected together according to the invention;

FIG. 22 is a bottom view of an embodiment of a folding table extension of one cart adjacent an integrated handle of another cart in preparation for connecting the two carts together according to the invention;

FIG. 23 is a bottom view of the folding table extension and integrated handle of the two carts of FIG. 22 connected together according to the invention;

FIG. 24 is a front elevation of two carts connected together according to the invention;

FIG. 25 is a bottom view of an embodiment of a folding table extension adjacent an embodiment of a second folding table extension with an embodiment of an alignment bar juxtaposed between the two in preparation for connecting the two carts according to the invention;

FIG. 26 is a bottom view of the components shown in FIG. 25 connected together according to the invention;

FIG. 27 is a perspective view of an embodiment of a cart assembly with various mounts attached to a pole being held by a pole support according to the invention;

FIG. 28 is a bottom view of an embodiment of a connecting corner table according to the invention;

FIG. 29 is a bottom view of the connecting corner table of FIG. 28 being used to connect folding table extensions of two carts in a right-angled configuration according to the invention;

FIG. 30 is a side view of an embodiment of a utility cart;

FIG. 31 is an end view of the embodiment of a utility cart shown in FIG. 30;

FIG. 32 is a perspective view of the embodiment of the utility cart shown in FIG. 30;

FIG. 33 is a top view of the embodiment of a utility cart shown in FIG. 30;

FIG. 34 is a side view of an accessory used with the embodiment of a utility cart shown in FIG. 30;

FIG. 35 is a side view of yet another accessory used with the embodiment of a utility cart shown in FIG. 30;

FIG. 36 is a conceptual view of the accessory of FIG. 34 as attached to the embodiment of a utility cart shown in FIG. 30;

FIG. 37 is a side view of the embodiment of a utility cart shown in FIG. 30 used in conjunction with the embodiment of a cart assembly shown in FIG. 1; and

FIG. 38 is a side view of an alternative connection mechanism configured to allow the embodiment of a utility cart shown in FIG. 30 to be used in conjunction with the embodiment of a cart assembly shown in FIG. 1.

### DESCRIPTION

Various embodiments will now be described with reference to the accompanying drawings. Many different embodiments could be created, and the present description should not be construed as limited to the embodiments set forth herein; rather, these embodiments are provided so that this disclosure will fully convey the scope of the inventive concepts to those skilled in the art. The terminology used in the description of the embodiments illustrated in the accompanying drawings is not intended to be limiting and like numbers in the drawings refer to like elements.

Turning now to the figures, which show various general views and details of an embodiment of a cart assembly 10. As illustrated, cart assembly 10 generally includes a top 12, a front 14, a left side 16, a right side 18, and a back 20. The cart assembly 10, though described as ideally suited for medical uses and sometimes referred to as a biomedical cart, is extremely versatile and provides an excellent solution to the cart needs of any industry.

The top 12 includes a top panel 30 that may optionally include a flat work surface 32, one or more recessed trays 34 of any shape or configuration for various purposes such as separating or controlling the unintentional migration of small objects. The top panel 30 is also shown as including one or more integrated handles 36. For ease of manufacturing and cleaning, in at least one embodiment the top panel 30 is of unibody construction using a contamination-resistant material such as a polymer or acrylic. In a hospital environment, it is beneficial to make the top panel 30 from a medical-grade, high-density polyethylene. The top panel 30 may further include a power cord access hole 38.

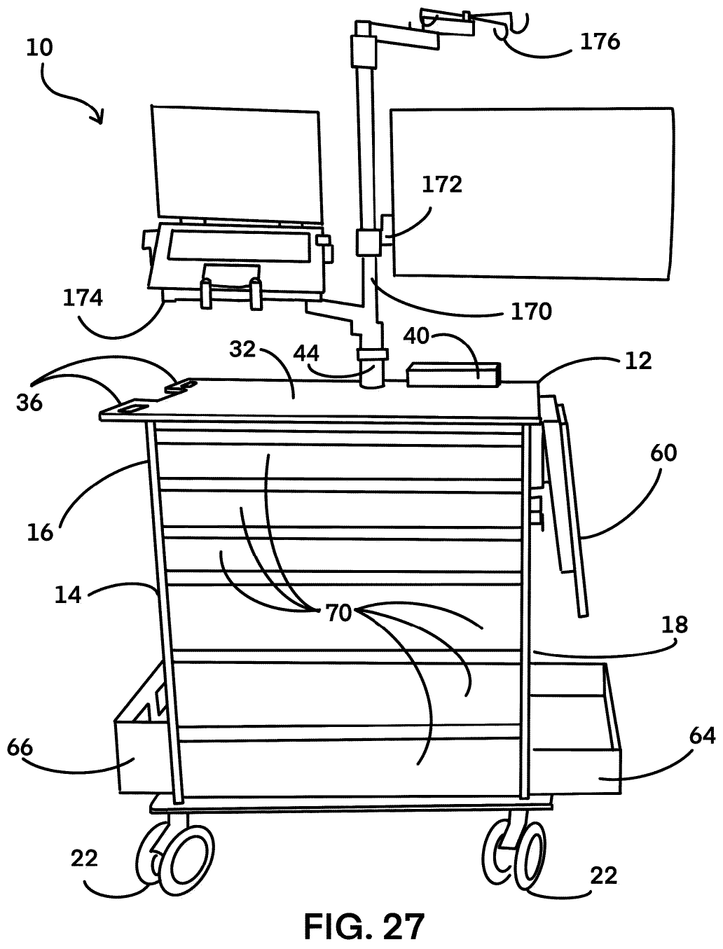

The top 12 may further accommodate accessories such as a power strip 40 and a pole support 44. In the embodiment shown in the Figures, the pole support 44 is affixed to the top panel 30 and comprises a tube extending vertically and sized to receive a pole 170 (see FIG. 27) to which other accessories may be attached. Non-limiting examples of these accessories may include articulating display mounts 172, laptop mounts 174, keyboard supports (not shown), intravenous (IV) bag holder 176, cord holders 42, drug delivery systems (not shown), etc.

One example of an accessory, shown in FIGS. is a cord holder 42 which may take on a variety of forms capable of holding and/or organizing cords. The cord holder 42 shown in the figures includes a lateral extension 50 and a vertical post 52 rising upward from the lateral extension 50 at an end opposite the pole support 44. The cord holder 42 provides a place to hang extra lengths of cords that are plugged into the power strip 40. The power strip 40 may be alternatively, or additionally, be located in a variety of locations, including but not limited to, the left side 16, the right side 18 or the back.

The front 14 of the cart assembly 10 features a plurality of drawers 70. The drawers 70 may be of different heights and are shown as increasing in height towards the bottom of the cart assembly 10. The drawers are of a high-quality construction and use sturdy, quiet soft-close drawer slides, as are known in the art, to facility quiet and smooth operation. In at least one embodiment, a lock 74 is provided to secure the contents of the drawers 70. The lock 74 in the cart embodiment shown in the figures is a smart programmable card access lock located beneath a folding table extension 60, located on either the left side 16 or the right side 18. This allows access to be given or removed easily by simply reprogramming an employee's access card, without having to alter the cart or manage physical keys. Naturally, several alternative locking mechanisms could be incorporated into cart assembly 10, such as mechanical locking systems.

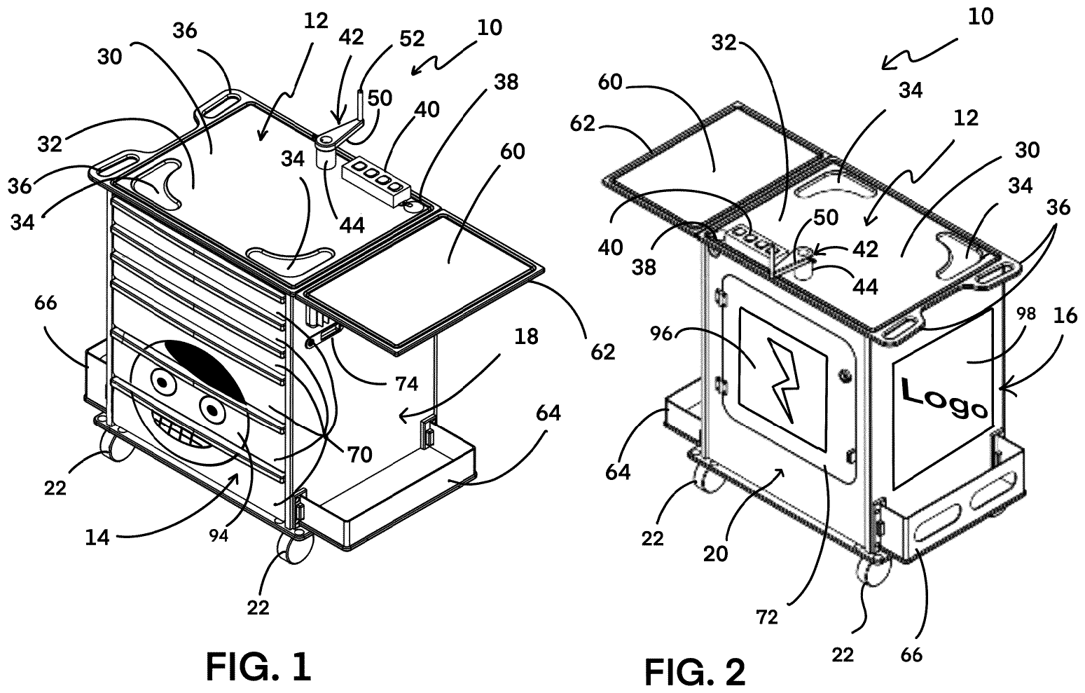

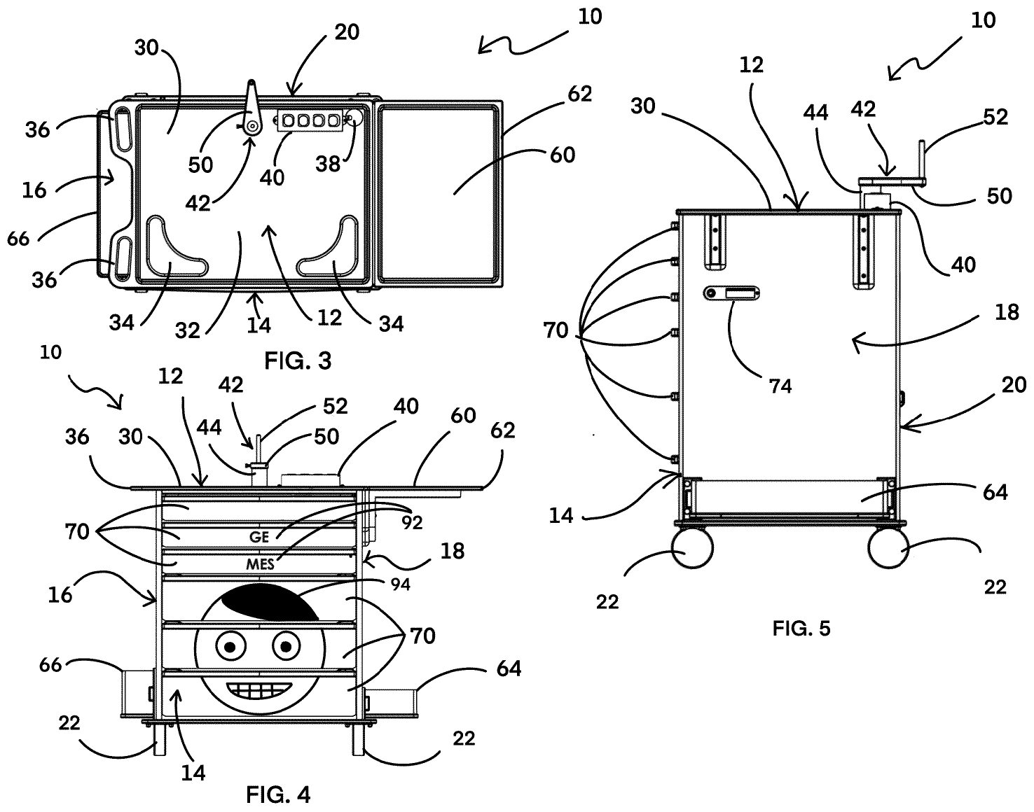

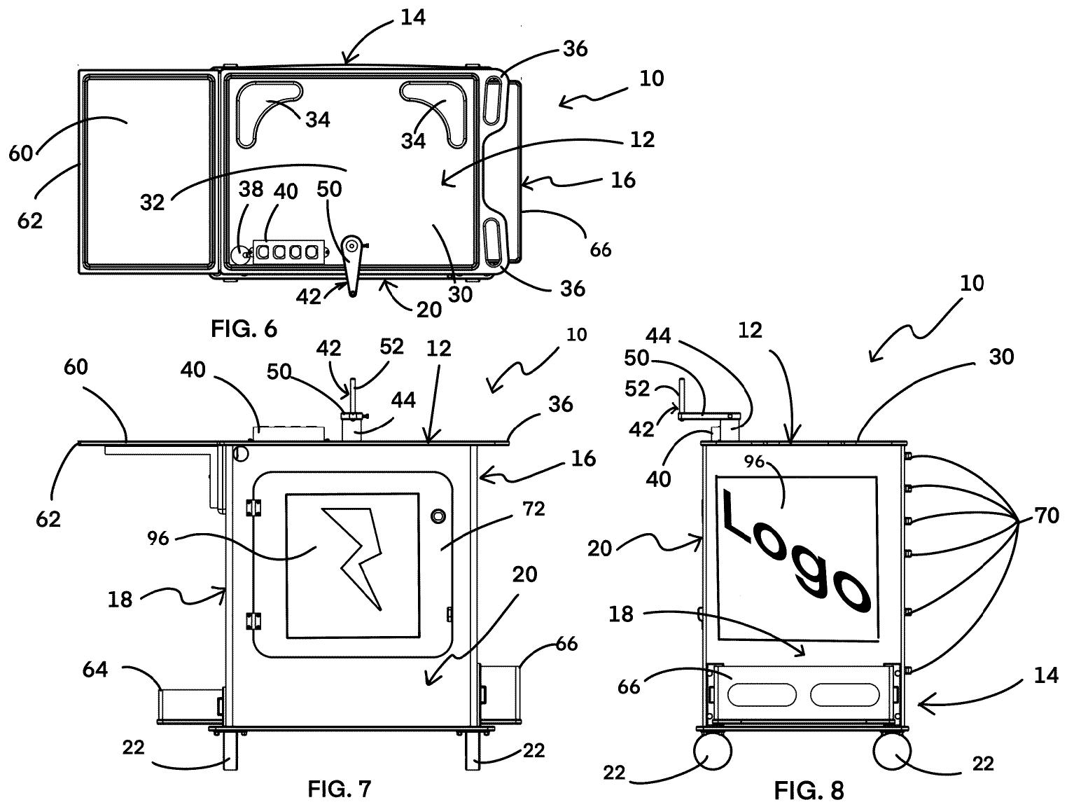

The right side 18 of the cart assembly 10 is shown best in FIGS. 1 and 5, which also illustrates a folding table extension 60. The folding table extension 60 may alternatively be located on the left side 16 or on both sides. The folding table extension 60 increases the size of the working surface of the cart assembly 10 when in the extended position. When not in use, the folding table extension 60 may be folded down so that it rests parallel to the right side 18 surface. A hinge catch mechanism (not shown) is used to hold folding table extension 60 in place, and may be a known mechanism familiar to those skilled in the art.

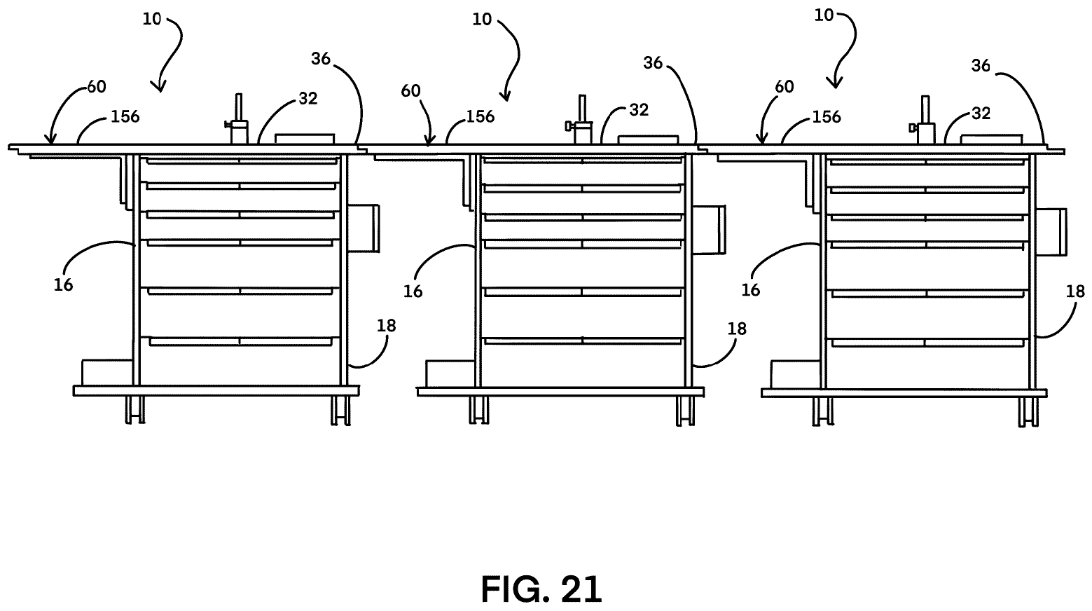

In at least one embodiment, the cart assembly 10 is customizable such that the folding table extension 60 may be located on either side and further, and is shaped, configured, or designed to include an interlocking feature that allows a distal end 62 of the folding table extension 60 to interlock, connect, or otherwise mate with a distal edge of an adjacent cart assembly 10. If it were desired to have the front 14 of both cart assemblies to be facing the same direction, one cart assembly 10 would have the folding table extension 60 on the left side 16 and the other would have the folding table extension 60 on the right side 18. The interlocking feature provided by the distal end 62 may take on various forms depending on the needs of the user. For example, if the environment in which the carts 10 are being used is one in which the carts 10 are unlikely to encounter heavy jostling or similar contact, and/or a quick and smooth transition between adjacent surfaces is important, the distal ends 62 of adjacent carts may include magnetic connectors. Alternatively, if the carts are going to be pulled as a single unit, a mechanical connector, such as latches, or other interlocking features may be used. An exemplary embodiment of an interlocking feature is shown in FIGS. 21-25 and described in more detail below.

The right side 18 is also shown as optionally including a right basket 64 that may be convenient for storing taller items such as liquid bottles, cleaning supplies, etc. Similarly, a left basket 66 is optionally provided on the left side 16.

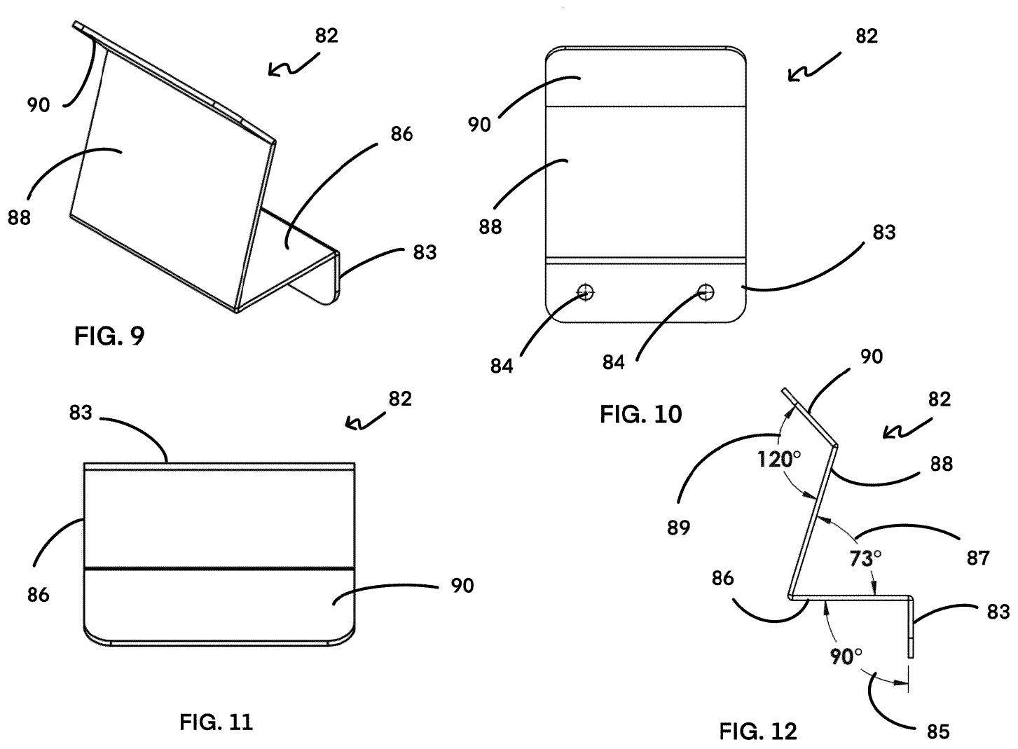

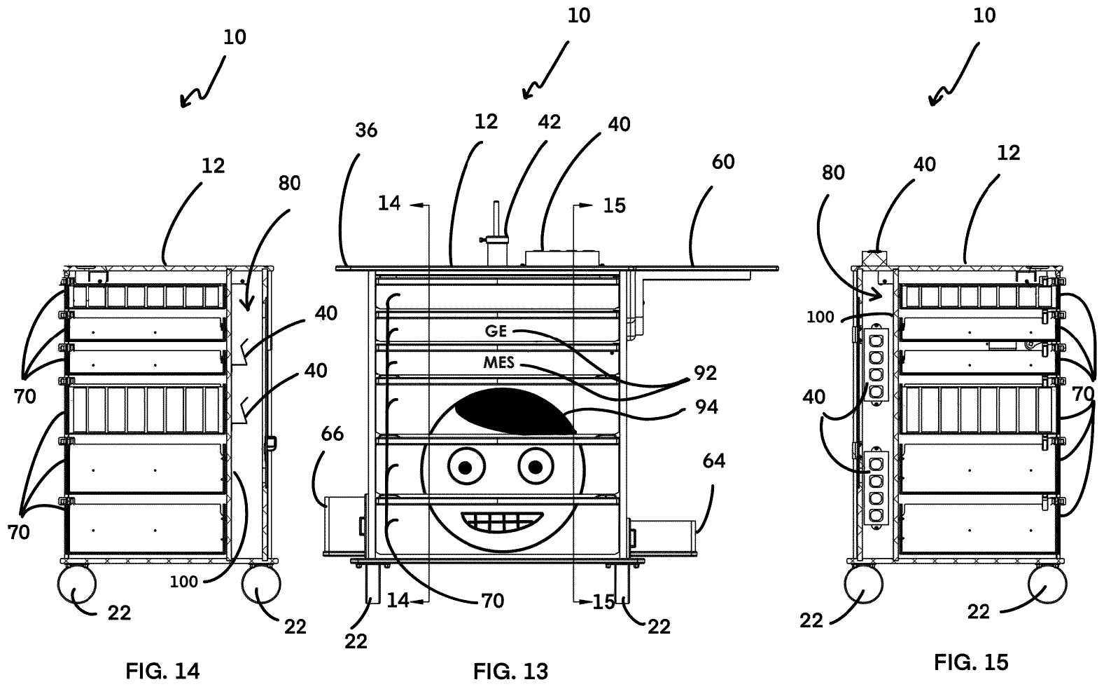

The back 20 of the cart assembly 10 includes a door 72 that opens to reveal a cord locker 80. The cord locker 80 contains one or more cable managers 82. An embodiment of a cable manager 82 is shown in FIGS. 9-13. The one or more cable managers 82 may include a mounting surface 83 defining mounting holes 84 used to affix the cable manager 82 to an interior wall 100 defining the back of the cord locker 80. The cable manager 82 may optionally be economically formed from a sheet of any bendable material, such as aluminum, or moldable/formable like plastic. The cable manager 82 shown in the figures includes a 90-degree bend 85 that forms a horizontal shelf 86, on which loops of cord may rest. Next, the cable manager 82 has an upward bend 87 to form a hook 88. The upward bend 87 is shown as forming an acute angle with the horizontal shelf 86 of approximately 73 degrees. Though this angle could obtuse or normal to the horizontal shelf 86, forming an acute angle allows room for a final, outward bend 89 to create an upper guide 90 that facilitates ease of use for one placing cord loops on the cable manager 82. It is further contemplated that the cable manager 82 could be configured in many different ways, such as straps or clips that would allow cables to be easily contained.

The cord locker 80, as seen in FIGS. 14-16, also includes one or more, in this embodiment two, additional power strips 40. Additional power strips 40 are provided due to the large number of electronics commonly used with biomedical carts. The cord locker 80 thus provides an ideal solution to providing power outlets and cord storage in an enclosed space that prevents the cords from interfering with moving and operating the cart assembly 10. As previously mentioned, the top 12 may include a power cord access hole 38. This power cord access hole 38 leads to the cord locker 80 such that the outlets on the power strips 40 may be easily accessed and allows the door 72 to remain closed during use. The cord locker 80 also provides some storage capabilities should this be needed.

The cart assembly 10 is supported by four casters 22. In at least one embodiment, the casters 22 are large, robust components (in this embodiment five inches in diameter) to allow smooth rolling over various surfaces. The casters may also be static displacing to protect electronic equipment carried by the cart assembly 10 from potentially adverse effects of static electricity. One or more of the four casters 22 may include a locking feature, as is known in the art. In at least one embodiment, the casters 22 not only have a large diameter, but also soft rubber contact surfaces as well along with high-quality bearings such that the cart meets the often-strict sound requirements found in hospitals.

In at least one embodiment, the cart assembly 10 is highly customizable. For example, scratch-resistant, panels 92, 94, 96 may be provided to cover many surfaces of the cart 10, including the drawers, the back, and the sides of the cart assembly 10. These panels are available in a variety of colors and are constructed from a material, such as aluminum, which is receptive to modern printing techniques, such as sublimation printing.

Sublimation printing is a printing technique in which a design is transferred from a transfer paper having a design printed thereon using special sublimation inks. In typical practice, the paper is placed on a receiving surface and heated until the ink enters a gaseous state and infiltrates the surface on a molecular level. Because the ink is transferred as a gas, and not as a film, the ink is not subjected to scratches, fading, peeling, or cracking. The resulting image is a vibrant, lasting high-resolution design. As such, using panels 92, 94, 96 upon various surfaces of the cart 10, provides designs and labels in which not only are the colors customizable, but branding and/or drawer identifiers may be provided, without the need for customer labeling devices, which can fade and peel over time.

In at least one embodiment, the panels 92, 94, 96 are laminate panels that are easily applied to one or more of the outside surfaces of the cart. These surfaces then become substrates for the printable panels and may be any or all of the vertical surfaces including the drawer fronts. The laminate panels are constructed of any material, such as aluminum, which accepts sublimation printing. These panels may be attached magnetically to the substrate surfaces, or there may be other attachment means provided such as upper and lower slots sized to allow the panels to be slid into place. Further, in certain embodiments, panels 92, 94, 96 are permanently attached to the corresponding surfaces of the cart assembly 10 using various attachment approaches, such as adhesives of locking connectors.

It is within the scope of the invention to take advantage of the versatility of these printable panels to allow the cart to be repurposed quickly and repeatedly, if needed, by swapping panels to convey different information, such as drawer contents, use status, warnings, colors, advertisements, and the like. It is also contemplated that the drawer panels present a one or more larger designs that occupy multiple drawers.

The figures show various examples of labels and designs that illustrate the versatility of the panels. For example, in FIG. 1, a large design 94 is shown that resembles a smiling face that occupies the fronts of three drawers. FIG. 2 shows a panel 96 that conveys a warning that electricity is present, and another panel 98 with a logo printed on it. FIG. 4 shows panels 92 being used to convey the contents of the drawers 70 on which they are placed.

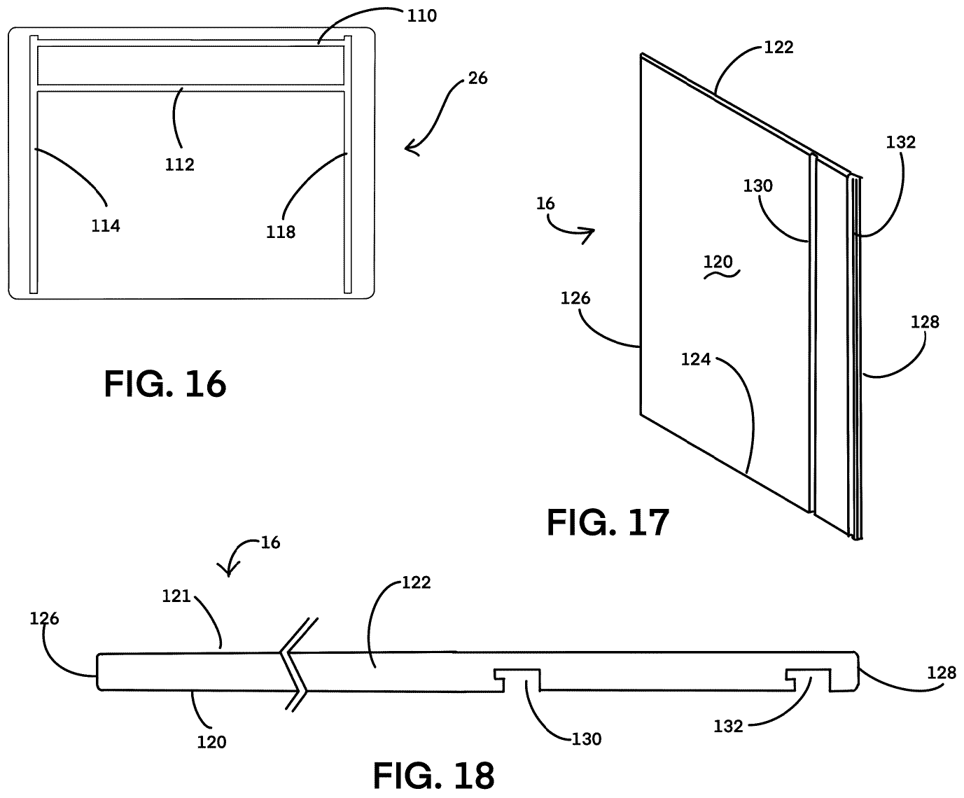

It is mentioned above that many facilities, such as hospitals, have noise limitations that must be met. In addition to using high-quality, large diameter casters 22, sound can be reduced through sturdy construction practices. For example, referring to FIGS. 16-20, it is shown that at least one embodiment of the cart assembly 10 utilizes interlocking panel construction to prevent rattling while the cart is being used or transported. For example, FIG. 16 shows a floor panel 26 having recessed floor slots 110, 112, 114 and 116. Floor slot 110 receives a bottom edge of the back 20. Floor slot 112 receives a bottom edge of the interior wall 100. Floor slot 114 receives a bottom edge of the left side 16 and floor slot 116 receives a bottom edge of the right side 18. These slots add rigidity to the overall construction of the cart 10 and serve to dampen vibrations to the walls received by the slots.

Additionally, FIG. 17 shows an embodiment of a side wall usable for either left side 16 or right side 18 (understanding that left side 16 and right side 18 are mirror images of each other, the side wall shown may be inverted to serve as either wall). For purposes of clarity, the side wall shown in FIG. 17 will be described as left side 16 since the orientation shown is correct for left side 16. The embodiment of left side 16 shown in FIG. 17 has an interior side 120, an exterior side 121 opposite the interior side (hidden in FIG. 17), a top edge 122, a bottom edge 124, a front edge 126, and a rear edge 128. Additionally, the interior side 120 has a mid-groove 130 and a rear groove 132. The mid-groove 130 and the rear groove 132 are shown in greater detail in FIG. 18, which is a top view of the left side 16.

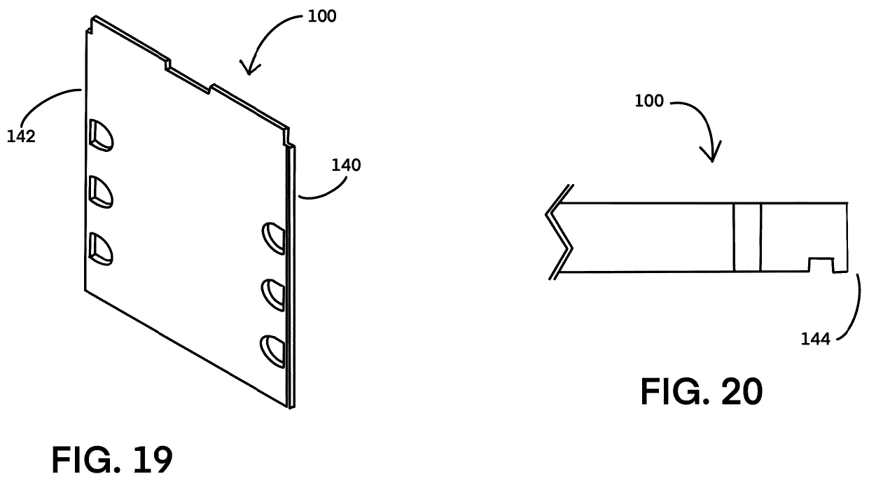

The grooves 130 and 132, in this embodiment, are identical except for their locations, in order to ease manufacturing. Each groove 130 and 132 have an “L” shape that receives a correspondingly shaped, interlocking tongue found on the edges of the walls received by the grooves 130 and 132, shown and described in FIGS. 19 and 20.

The mid-groove 130 is positioned to accept the interior wall 100, which is shown in FIG. 19. The interior wall 100 includes side edges 140 and 142 having tongues that are configured to mate with the mid-groove 130 of a corresponding side wall. An example of a tongue 144 is shown in FIG. 20. The tongue 144 has an “L” shape that slides into the “L” shaped groove 130 or 132. This configuration greatly reduces noise and provides the cart assembly 10 with a sturdy, high-quality construction.

FIGS. 21-25 depict embodiments by which more than one cart assembly may be connected together to form an extended work surface. FIG. 21 shows three cart assemblies 10, each including a folding table extension 60 located on its left side 16, and a one or more integrated handles 36 on the right side 18. Each folding table extension 60 is connected to the one or more integrated handles 36 of the adjacent cart assembly 10.

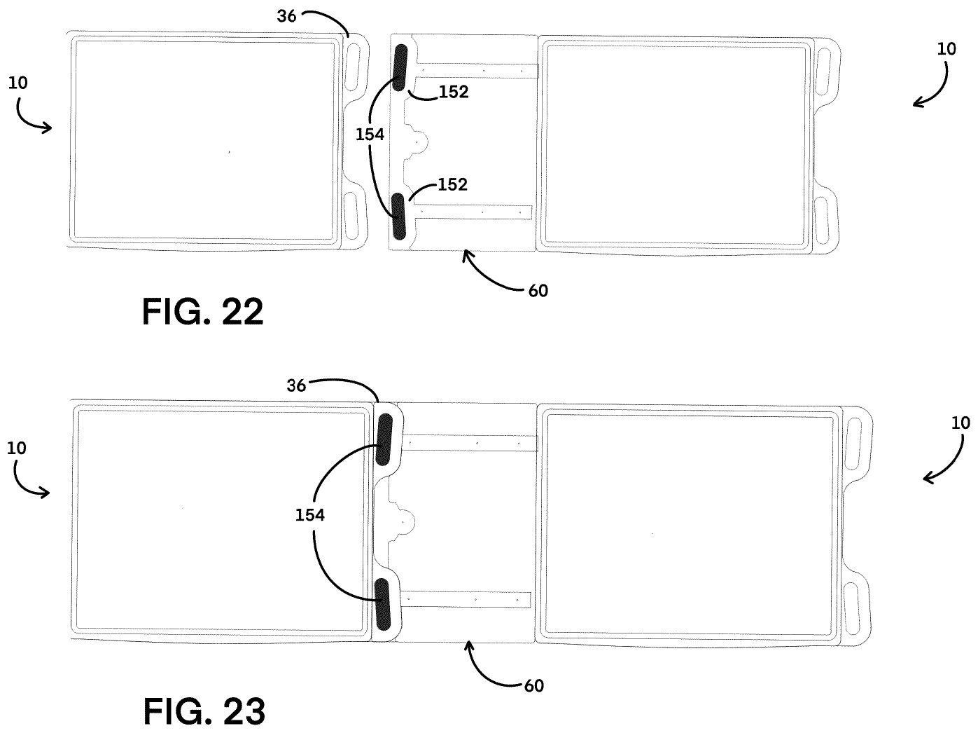

FIGS. 22-23 are bottom views that show the connection between a folding table extension 60 of one cart assembly 10 and the integrated handles 36 of an adjacent cart assembly 10. The folding table extension 60 has a bottom surface 150 that includes areas 152 where material has been removed. These areas 152 are shaped to form downward extending pegs 154, that are shaped to mate with the one or more integrated handles 36 of the adjacent cart assembly 10. FIG. 22 shows the two cart assemblies 10 in a disconnected state while FIG. 23 shows them in a connected state. Referring back to FIG. 21, the one or more integrated handles 36 extend below the flat work surface 32 by a depth that approximates the thickness of the areas 152 such that, when connected, a top surface 156 of the folding table extension 60 is relatively flush with the flat work surface 32.

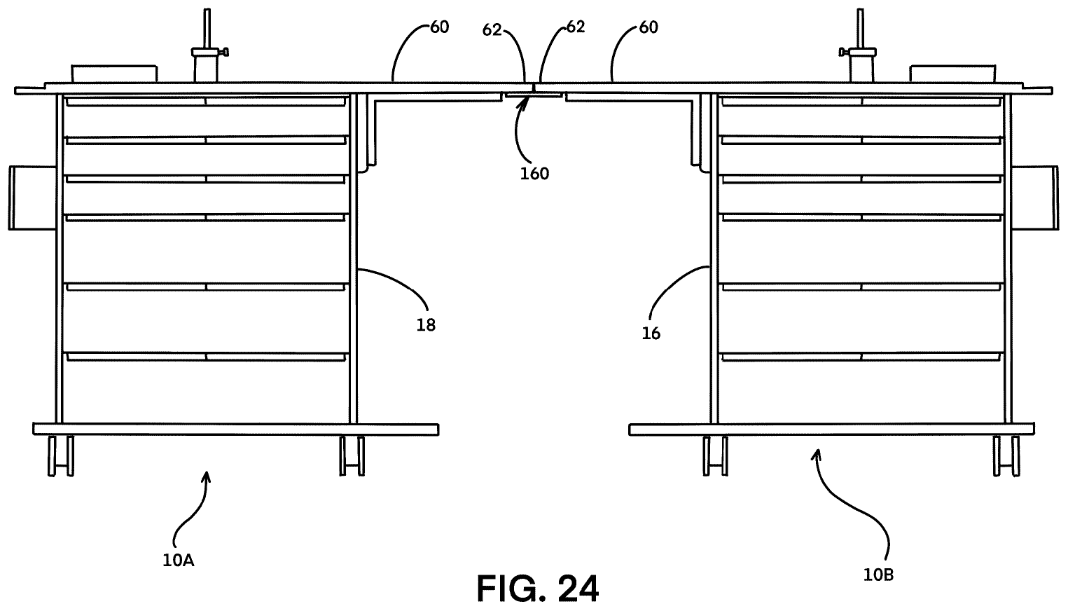

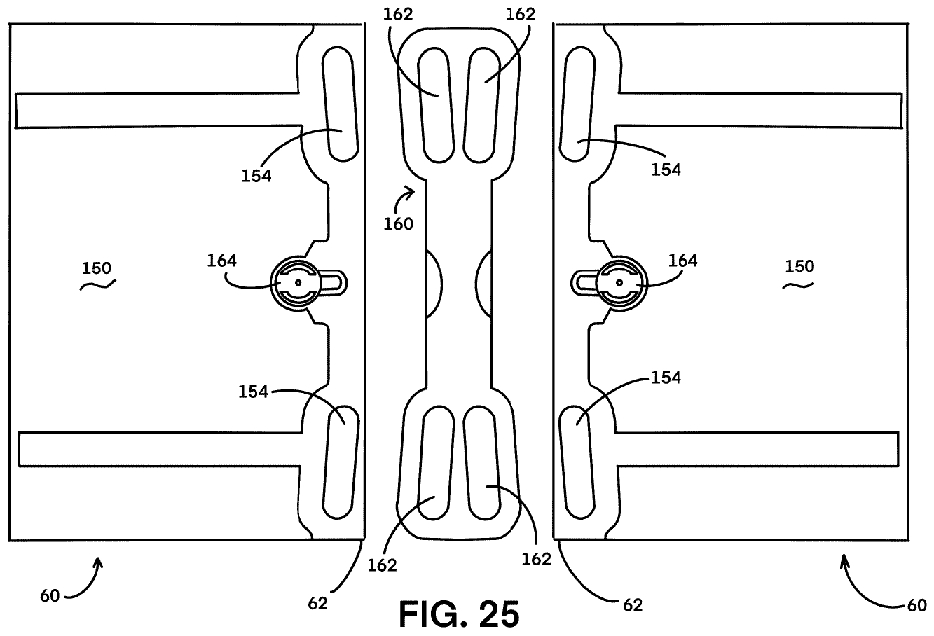

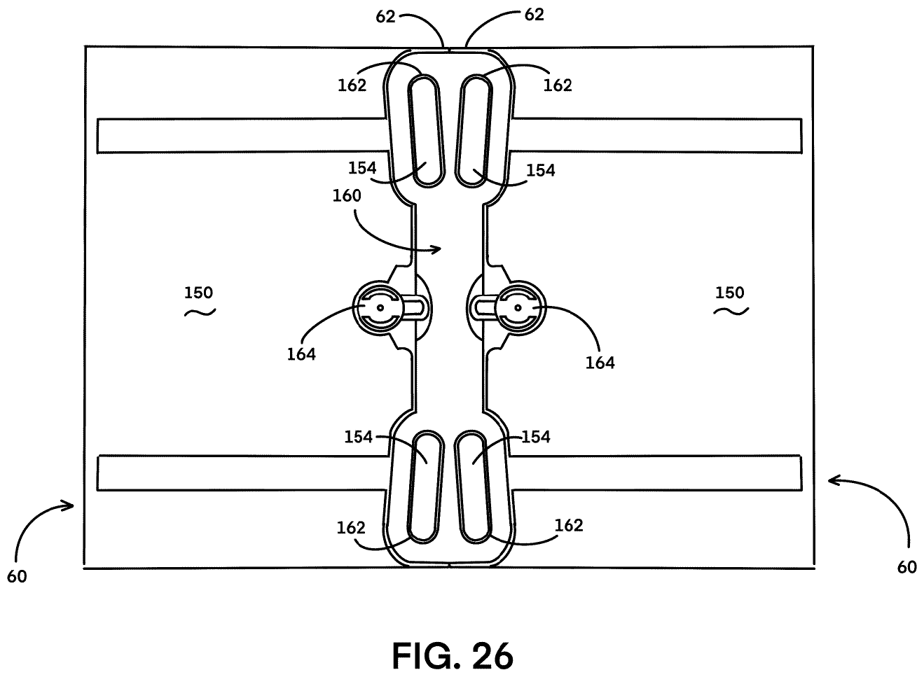

FIGS. 24-26 show an embodiment whereby a first cart assembly 10A has a folding table extension 60 on its right side 18 and second cart assembly 10B has a folding table extension 60 on its left side 16. The folding table extensions 60 are connected together at their distal ends 62 using an alignment bar 160 detailed in FIGS. 25 and 26.

The alignment bar 160 replicates the integrated handle 36 shape such it can be used with the existing folding table extension 60 design. More specifically, the alignment bar 160 takes a form that is similar to back-to-back handles in that there are four handle cut outs 162 that are spaced and oriented to mate with the downward extending pegs 154 of abutting folding table extensions 60. The alignment bar 160 is thus placed on the bottom surfaces 150 of the adjacent folding table extensions 60 in order to engage the downward extending pegs 154. In order to retain the alignment bar 160 in place, each folding table extension 60 has a rotating catch 164.

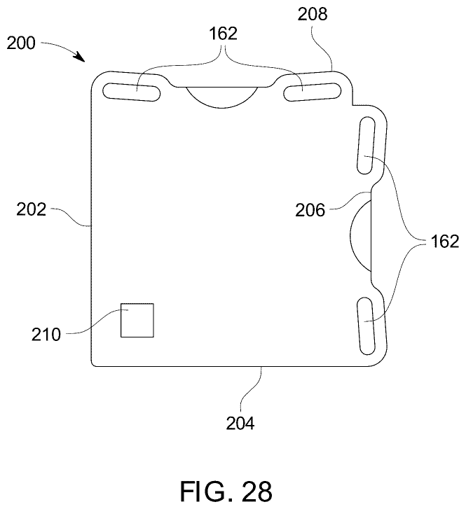

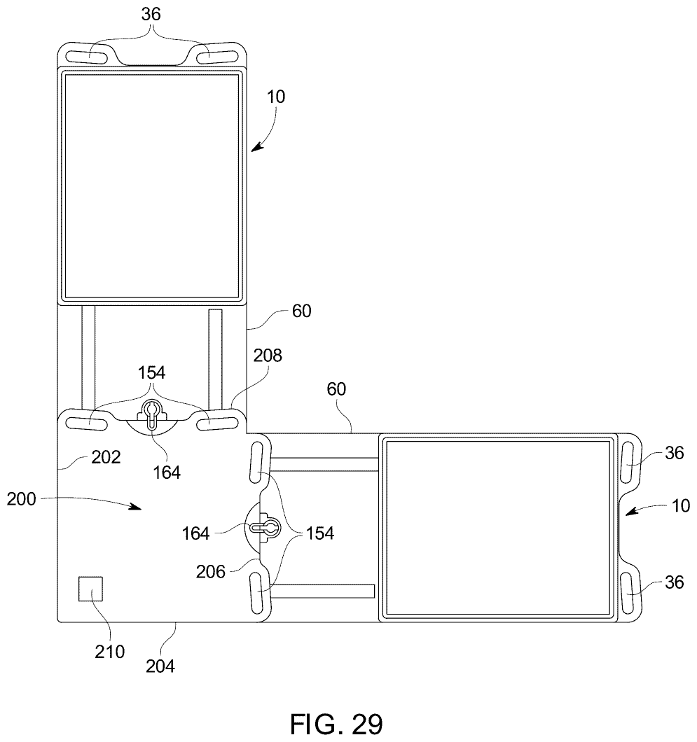

FIGS. 28 and 29 depict another connected configuration according to an embodiment of the invention using a corner table attachment 200. The corner table attachment 200 has four sides 202, 204, 206 and 208. Sides 202 and 204 are straight sides while sides 206 and 208 are configured similarly to the sides of the alignment bar 160 shown in FIGS. 25 and 26. Like the sides of the alignment bar 160, the sides 206 and 208 replicate the integrated handle 36 shape such the corner table attachment 200 can be used with the existing folding table extension 60 design. More specifically, each side 206 and 208 has two handle cut outs 162 that are spaced and oriented to mate with the downward extending pegs 154 of abutting folding table extensions 60. The corner table attachment 200 is thus placed on the bottom surfaces 150 of the adjacent folding table extensions 60 in order to engage the downward extending pegs 154. In order to retain the corner table attachment 200 in place, each folding table extension 60 has a rotating catch 164.

In order to add support to the corner table attachment 200, and increase the weight it can hold, a support leg 210 may be provided in one or more corners of the corner table attachment 200 and may be foldable, collapsible, telescoping, removable or any other configuration or construction for making the corner table attachment 200 easily storable when not in use.

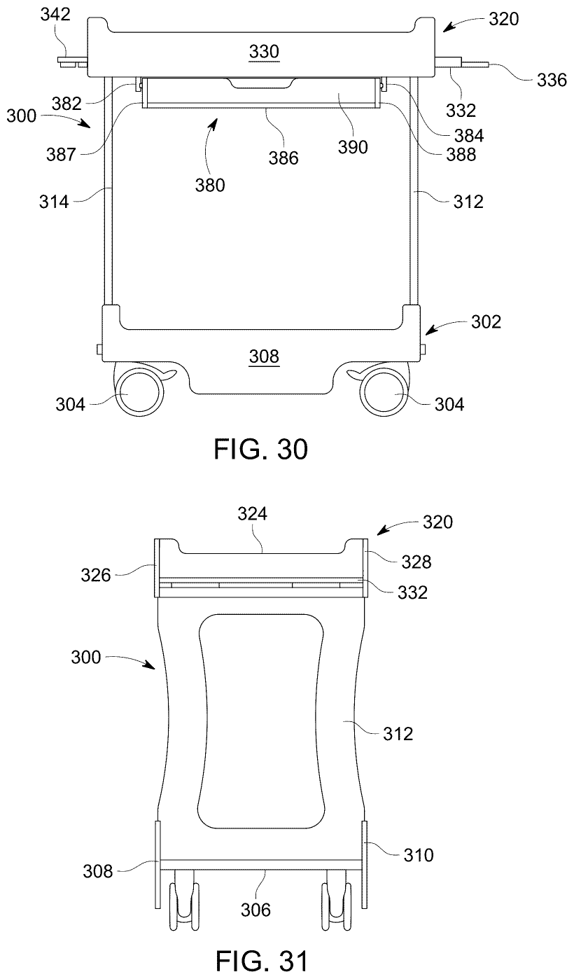

Turn now to FIG. 30, a side view of an alternative embodiment of a utility cart 300 is shown. Utility cart 300 is uniquely configured to provide yet another tool for healthcare professionals when providing services. That said, utility cart 300 could be used in many other situations, such as building maintenance, retail stores, manufacturing stores, etc. This embodiment of utility cart 300 includes a base housing or base tray 302 having a plurality of wheels or casters 304 connected on a bottom side thereof. As will be appreciated, casters 304 are similar to the casters 22 discussed in the previous embodies above. More notably, casters 304 are also very robust, smooth rolling casters, which are specifically configured for use in a hospital or medical setting. Casters 304 also include a locking feature, which will provide additional functionality for users. In addition, it is beneficial to have certain casters 304 which are configured to be directionally secured in a particular alignment. For example, casters 304 an end of cart 300 opposite handle 336 are configured to be directionally locked in-line with the longitudinal direction thereof and casters 304 closer to the handle will swivel, so that all “steering” is achieved by swiveling casters. Alternative configurations are possible.

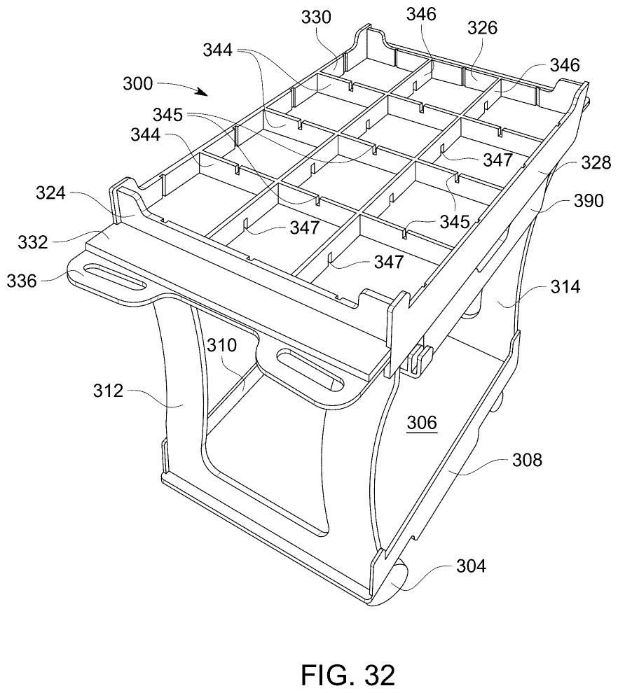

As will be recognized, base housing or base tray 302 is configured to have a bottom support surface 306, a first sidewall 308 and a second sidewall 310. Several of these components (base platform 306, first sidewall 308, and second sidewall 310), are illustrated in the end view shown in FIG. 31. To better illustrate certain components, FIG. 32 provides a perspective view of utility cart 300, which is shown from a handle end. As will be appreciated, base platform 306 is configured to support components, parts, tools, etc. which are placed in utility cart 300 while in use. First sidewall 308 and second sidewall 310 help to contain items within this area. As also shown, casters 304 are coupled or attached to a bottom surface of base platform 306, which provides support and cooperation with these components. Although not shown, it is understood that several triangular support brackets could be coupled to support surface 306 and either first sidewall 308 or second sidewall 310 to better provide rigidity. These triangular support brackets could be coupled using the groove and slot connection type structures discussed above in relation to FIGS. 18-20.

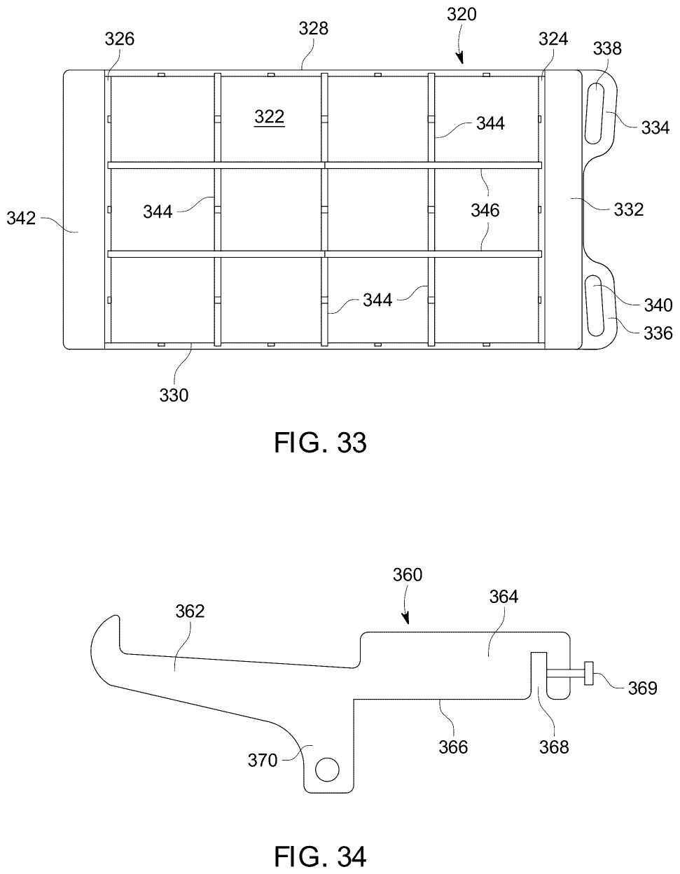

FIGS. 30-32 also illustrate how this embodiment of utility cart 300 also has a first upright sidewall 312 and a second upright sidewall 314. Attached to an upper end of a first upright 312 and a second upright 314 is an upper tray 320, which provides additional utility and functional for utility cart 300. As further illustrated in other figures, upper tray 320 includes a supporting surface 322 surrounded by a first end wall 324 and a second end wall 326. Additionally, a first sidewall 328 and a second sidewall 330 also cooperate with supporting surface 322 to create a storage area within upper tray 320. As will be appreciated, the storage area within upper tray 320 to create a storage area within upper tray 320. can be utilized to contain and carry various items (supplies, components, tools, utensils, etc.). Also, extending from upper tray structure 20, at a first end adjacent to first end wall 324 is a handle structure 332. As best illustrated in FIG. 33, handle structure 332 has a first handle member 334 and a second handle member 336 which each have openings 338 and 340, respectively. Openings 338 and 340 provide structures for users to grab, manipulate or move utility cart 300, as needed. At another end of upper tray structure 320 is a supporting shelf 342 which can be utilized for many different purposes, as will be discussed in further details below.

Referring now to FIG. 30, utility cart 300 includes an integrated drawer 380 which is mounted to an underside of upper tray 320 using first slide 382 and second slide 384. To provide a functional resource, integrated drawer 380 is configured to have a bottom surface 386 and attached sidewalls 387 and 388, along with a front wall 390 and a rear wall 392, all coupled to one another in a manner to for an open box-like drawer structure. In this embodiment, first drawer slide 382 and second drawer slide 384 are configured to cause integrated drawer 380 to be self-closing, and to have smooth sliding bearings thus allowing easy operation. It is also noted that integrated drawer 380 is optional and could be omitted. Further, the size (i.e., width and depth) of integrated drawer 380 could be changed to provide more or less storage, depending upon the needs of the user.

As best shown in FIG. 33, this embodiment of utility cart 300 also includes a plurality of cross dividers 344, and lateral dividers 346, which can be inserted into upper tray 320 to create a number of compartments 350. Each compartment is capable of containing components, tools, or items as needed by the user. As will be appreciated, cross dividers 344, and lateral dividers 346 are notched and removable, which allows users to configure the storage area above support surface 320 in anyway that they desire. In this illustrated embodiment, cross dividers 344 and lateral dividers 346 couple together via appropriate notches (or slots) to provide a rigid storage structure which can be configured in many different ways. Additionally, the various dividers could be configured in a number of ways by removing and reconfiguring as needed for a particular use, thus providing the ability to create specialized compartments as desired.

Using concepts similar to cart assembly 10, each of the components forming utility cart 300 are configured to interlock with one another to provide added strength. As one example, first sidewall 308 and second sidewall 310 are configured to have slots or grooves (also referred to as install grooves) proximate to both ends which are configured to receive first upright 312 and second upright 314. Base platform 306 will include similar slots or grooves which are designed to receive a lower end of first sidewall 308 and second sidewall 310. By closely controlling the tolerance of components making up utility cart 300, these components will be closely coupled and to one another creating a “solid” structure that provides the desired level of rigidity. Further, the use of “L” grooves and related tongue structures, similar to those illustrated in FIGS. 18-20 and discussed above, provides an interlocking connection which results in a very robust structure and provides utility cart 300 that has very solid feeling. Additionally, it is possible that very few connectors can be used. To create additional rigidity, angled support brackets (not shown) can be used throughout utility cart 300.

Components of utility cart 300 are generally formed of a contamination-resistant material such as a polymer or acrylic. Similar to certain components discussed above, it is helpful if elements are formed from a medical-grade, high-density polyethylene to allow use in a hospital environment. This allows for the ability to easily clean and sanitize utility cart 300.

In certain instances, it is desirable to have the ability to attach or hang items from portions of utility cart 300. In one embodiment, an accessory hook 360 is utilized for accomplishing this function. In this embodiment accessory hook 360, illustrated in FIG. 34, is design and configured to be attached to upper tray structure 320, adjacent first end wall 326 and shelf portion 342. FIG. 34 more specifically provides a side view of accessory hook 360 which is configured to interact with related portions of upper tray structure 320. A hook portion 362 extends outwardly from a main body 364, with hook portion 362 being configured to hold or support other components. In one example, if a pair of accessory hooks 360 are attached to upper tray structure 320, to support a ladder or stool which could then be hung from utility cart 300. As also shown, main body 364 is configured to be positioned upon and supported by lateral shelf portion 342 of upper tray structure 320. A supporting surface 366 of main body 364 is intended to be positioned directly upon shelf portion 342 in order to provide desired support. In order to contain utility or accessory hook 360, a retaining slot 368 exists on a lateral end of accessory hook 360 which is designed to surround and couple with second end wall 326. Further, accessory hook 360 makes use of a set screw 369, which can allow for secure attachment of accessory hook 360 to utility cart 300. A lower supporting structure 370 is also part of accessory hook 360, which also provides for lateral support when coupled to upper tray structure 320.

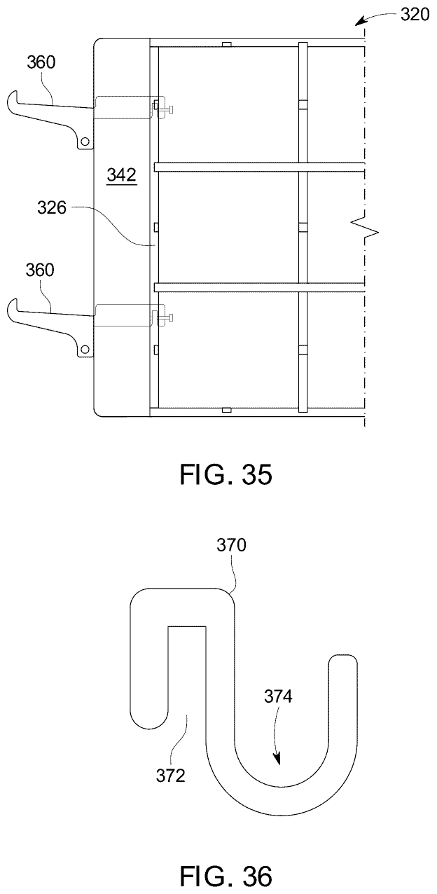

Referring now to FIG. 35, which provides an additional view of how accessory hook 360 might be coupled to upper tray structure 320. Here, accessory hooks 360 are shown laid out adjacent to upper tray 320 to illustrate potential positioning. In use, it will be anticipated that accessory hooks 360 would be rotated 90 degrees from this illustrated position when finally attached to upper tray structure 20. As shown, it is possible for accessory hook 360 to be positioned anywhere along shelf portion 342, which will provide flexibility and additional functionality for utility cart 300.

Yet an additional accessory as illustrated in FIG. 36. Here, a side view of a hanging hook 370 is shown, which includes a supporting slot 372 configured to surround any portion of first sidewall 328 or second sidewall 330. When coupled to utility cart 300 hanging u-hook 374 emanates from either of the above-mentioned sidewalls, whilst allowing any type of accessory to be hung or carried by utility cart 300. When accessory U-hook 370 is coupled to either first sidewall 328 or second sidewall 330, u-hook 374 will provide additional functionality and tools for users, allowing the utility cart 300 to be configured as desired.

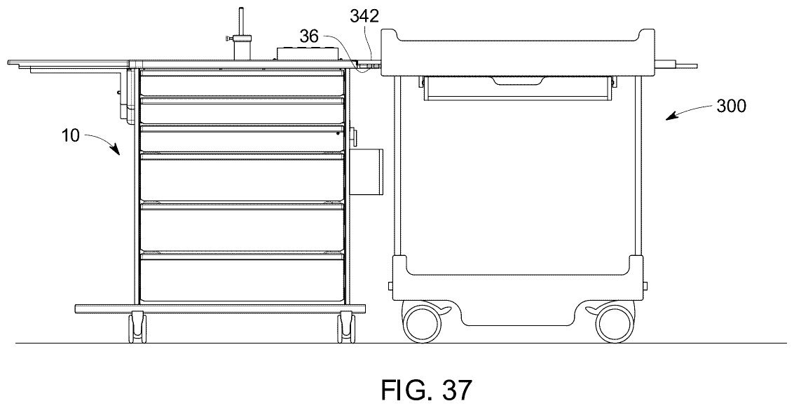

As generally discussed above, the ability to connect various components to create useful structures, including the ability to couple multiple carts with one another, is a valuable capability for users. As illustrated in FIG. 37, one methodology for such connection is shown. Here cart assembly 10 is shown as coupled to utility cart 300, by having integrated handle 36 of cart assembly 10 receive complementary structures that exist in a bottom side 343 of shelf structure 342. This will occur in a manner very similar to the coupling mechanisms discussed above. More specifically, bottom portion 343 of shelf portion 342 will include structures very similar to downward extending pegs 154 discussed above. The structures will then be inserted into openings in handle structure 36, thereby allowing for direct coupling of the carts to one another. When configured in this manner, the coupled cart assembly 10 and utility cart 100 can function as a single unit.

Although not shown, it is possible that utility cart 300 will have handle structures 332 at both ends of utility cart 300. In that situation, a separate coupling plate could be used to couple an adjacent utility cart, similar to alignment bar 160 or corner table attachment 200.

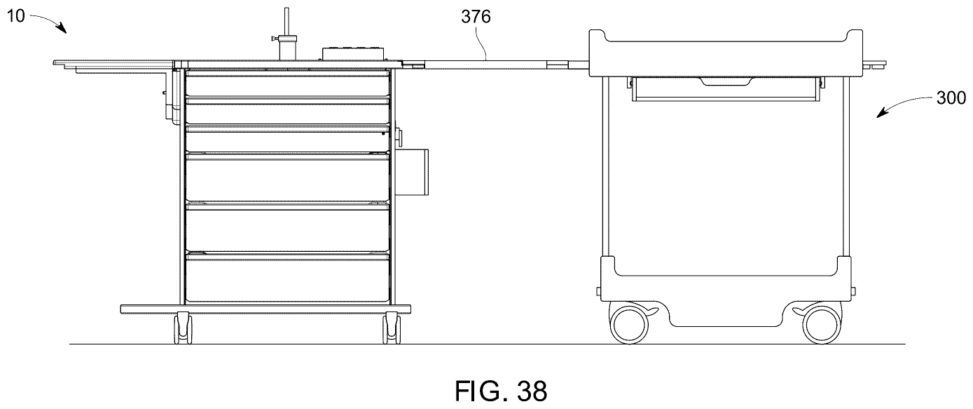

Again, it is often necessary to add or create shelves or to extended work surfaces for many different purposes. FIG. 38 illustrates an example configuration for this type of configuration, where an extending shelf 376 is coupled between utility cart 300 and cart assembly 10. It is anticipated that a coupling structured, very similar to that discussed above, can be utilized to achieve this desired configuration. Again, when utility cart 300 and cart assembly 10 are coupled together, this assembly can operate and be moved as a single unit while also providing additional tools for users.

Although the various embodiments have been described in in light of various configurations and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A utility cart, comprising:
a base tray comprising a support panel having an upper surface and plurality of upward walls surrounding the support surface and forming a lower compartment, the base tray further having a plurality of casters attached to a lower surface of the support panel which allows the base to be easily movable along a supporting surface;
a first end panel coupled to the support panel and extending upwardly therefrom, the first end panel being substantially planar with an opening therethrough allowing a user to access the compartment, wherein a lower portion of the first end panel forms a first upward sidewall of the base tray;
a second end panel coupled to the support panel and extending upwardly therefrom, the second end panel being substantially planar with an opening therethrough allowing a user to access the compartment, wherein a lower portion of the second end panel forms a second upward sidewalls of the base tray;
an upper tray comprising a supporting panel coupled to a upper portion of the first end panel and an upper portion of the second end panel, a first tray sidewall and a second tray sidewall both coupled to the supporting panel; and
a handle extending from a side portion of the upper tray, the handle having a coupling structure on a portion of the handle opposite the side portion of the upper tray, wherein the coupling structure is configured to be attachable to a similar coupling structure existing on a related device.

2. The utility cart of claim 1 wherein the related device comprises a second utility cart configured to have a handle attached thereto which has a coupling structure to the coupling structure.

3. The utility cart of claim 2 wherein the upper tray is configured to receive at least one divider.

4. The utility cart of claim 2 wherein the handle structure has a plurality of openings and form a portion of the coupling structure, the coupling structure configured to be inserted into the plurality of openings.

5. The utility cart of claim 1 wherein the support panel is coupled to the first end panel and the second end panel using a plurality of slots and grooves configured to provide an interlocking connection, and wherein the upper tray is connected to the first end panel and the second end panel using a second plurality of slots and grooves configured to provide an interlocking connection.

6. The utility cart of claim 5 wherein the base tray further comprises a plurality of angled support brackets on a lower surface thereof coupled to the upward walls and the upper tray further comprise a plurality of angled supports on a lower side of the supporting surfaced coupled to the first tray sidewall and second tray sidewall.

7. The utility cart of claim 6 wherein the angled support brackets are coupled via mating grooves in the first tray sidewall and second tray sidewall.

8. The utility cart of claim 5 further comprising a storage drawer coupled to the upper tray at a location below the supporting surface, the storage drawer movable between an open position and a closed position.

9. The utility cart of claim 1 wherein each of the base tray, upper tray, first upright and second upright are formed of a medical-grade, high-density polyethylene.

10. The utility cart of claim 1 wherein at least two of the plurality of casters are adjustable directionally lockable so as to maintain a desired alignment.

11. A work assembly comprising the utility cart of claim 1, and wherein the related device is a cart assembly having a plurality of drawers, an upper work surface and a plurality of wheels to provide mobility, the cart assembly further configured so that the upper work surface is positioned at substantially the same height as the handle of the utility cart, the upper work surface having a handle extension at a first end thereof, the work assembly further comprising:
a connection plate interacting with the handle extension of the cart assembly and the coupling structure of the utility cart thereby coupling the utility cart and the cart assembly and allowing them to be moved as a single unit.

12. The work assembly of claim 11 wherein the connection plate comprises a plurality of mating structures that are received within openings in the handle extension of the cart assembly and the coupling structure of the utility cart to achieve the desired coupling.

13. The work assembly of claim 12 wherein a longitudinal axis of the utility cart and a longitudinal axis of the cart assembly are aligned at 90 degrees with respect to one another.

14. A utility cart for storing and transporting items, the utility cart comprising:
a lower tray comprising a support surface, first upward side wall positioned at a first side of the support surface, and a second upward side wall positioned at a second side of the support surface, and a plurality of casters attached to a lower surface of the lower tray opposite the support surface which allows the utility cart to be easily movable;
a first end panel coupled to the support surface of the lower tray and extending upwardly therefrom, the first end panel being substantially planar;
a second end panel coupled to the support surface of the lower tray and extending upwardly therefrom, the second end panel being substantially planar, wherein a lower portion of the first end panel and a lower portion of the second end panel, in conjunction with the first upward side wall and a second upward side wall form a lower storage compartment;
an upper tray comprising a supporting panel coupled to an upper portion of the first end panel and an upper portion of the second end panel, a first tray sidewall, a second tray sidewall, a first tray end wall and a second tray end wall, all coupled to the supporting panel to form an upper storage compartment; and
a handle extending from a first side portion of the upper tray, the handle having gripping openings therein, wherein the gripping openings are configured to be attachable to a coupling structure existing on a related device.

15. The utility cart of claim 14, further comprising a second handle structure extending from a second side portion of the upper tray, the second handle having gripping openings therein, wherein the gripping openings.

16. The utility cart of claim 15 further comprising a connection plate coupled to the handle that has extensions that can be inserted into the gripping openings.

17. The utility cart of claim 14 further comprising a shelf extending from a second side portion of the upper tray, the shelf having extension portions configured to mate with a gripping opening of the related device.

18. A cart unit comprising the utility cart of claim 1 and an identical second utility cart coupled to one another.
